(19) United States
(12) Patent Application Publication
(10) Pub. No.: US 2012/0207579 A1
(43) Pub. Date: Aug. 16, 2012

(54) METHOD FOR SEPARATION OF STACKS OF INTERFOLDED SHEETS IN AN INTERFOLDING APPARATUS

(75) Inventors: Simona Ricci, Montecarlo (LU) (IT); Andrea Bernacchi, Capannori (LU) (IT)

(73) Assignee: TISSUEWELL S.r. L., Montecarlo (LU) (IT)

(21) Appl. No.: 13/501,006

(22) PCT Filed: Oct. 8, 2010
(86) PCT No.: PCT/IB10/02564

§ 371 Date: Apr. 9, 2012

(30) Foreign Application Priority Data
Oct. 13, 2009 (IT) BO2009A 000661

(51) Int. Cl. B65G 57/02

(52) U.S. Cl. 414/802

(57) ABSTRACT

The method for automatic separation of bundles of interfolded sheet articles is carried out in an interfolding machine that includes a folding unit (100), aimed at cutting the articles (1), folding them and forming an interfolded stack (2), and that includes also a separating device (10), situated downstream of the folding unit (100). The separation method includes: supporting the base of the stack (2) by first supporting planes (A) of the separator (10); lateral introduction of second supporting planes (B) and subsequent forming of an underlying bundle (3) of articles (1); separation of the bundle (3) and release thereof onto a conveyor (20); upwards movement of the first supporting planes (A) until they are placed directly underneath the second supporting planes (B); re-inserting of the first supporting planes (A) under the base of the stack (2); withdrawal of the second supporting planes (B) from the base of the stack (2).

### BACKGROUND OF THE INVENTION

The present invention relates to the technical field concerning automatic machines for manufacturing and packaging articles of disposable tissue paper or of another similar absorbing material, into interfolded bundles.

In particular, the invention relates to a method for automatic separation of the above mentioned interfolded bundles, while the disposable articles are progressively interfolded and stacked at the outlet of the folding section of the interfolding machine.

### BRIEF DESCRIPTION OF THE PRIOR ART

It is known that different types of articles made of disposable paper, such as handkerchiefs, napkins, towels, toilet paper, etc. are often sold in the form of sheets, packaged in packs made of a certain number of folded sheets, stacked one over another and interfolded. This means that each sheet is folded by the aforesaid machine so as to obtain two or more folding layers, and consequently it is stacked so that the layers of the adjacent sheets of the stack are reciprocally co-penetrating. For example, in the case of three-layer folding, the first layer of a sheet is contained in the folding of the previous sheet and, the first layer of the subsequent sheet is in turn contained between the second and third layers. In this way, in use, by extracting a sheet from the pack of articles, also the first layer of the subsequent sheet is withdrawn. This facilitates the subsequent extraction of the subsequent sheet.

The most common conventional interfolding machines include a plurality of rollers arranged in two different sequences, each of which receives a tape of material from which the articles are obtained. The tape is first cut into sheets of suitable dimensions and then conveyed towards a pair of counter-rotating folding rollers, so that a sheet coming from one direction and conveyed by a roller partially overlays the sheet conveyed by the other roller.

At the outlet of the folding rollers, the partially overlaid sheets are taken by a pair of oscillating comb devices, provided with a plurality of folding fingers, parallel to one another, that separate the overlaid portions of two subsequent sheets from each roller and form the interfolded stack. The folding fingers move along a close path that includes a first end position, in which the fingers are introduced into suitable grooves made in the folding rollers, and a second end position, in which the fingers protrude outwards of the aforesaid rollers, bringing with them a layer of the coming sheet, so as to put it on the stack being formed.

The known comb devices are hinged on axes parallel to those of the folding rollers and are generally moved in step relation with the sheets forward movement on the rollers, by means of a mechanism equipped with connecting rod-crank assemblies operated by cam guides.

Downstream of the folding devices, the growing stack of interfolded articles is supported by a horizontal table, moved away by the folding devices with the same speed as the stack growth speed. The bundles of desired dimensions are then withdrawn from the stack, with the frequency depending on the growth speed and on the dimension of each bundle. The single bundles are then directed toward further manufacturing steps, such as the cutting to the size and the packaging.

The bundles can be withdrawn manually, by specifically assigned operators, or by means of suitable automatic separating devices.

Some types of known devices for the automatic separation of the known bundles include one or more moving separators, aimed at entering the growing stack and at withdrawing therefrom portions of suitable height. The operational sequence of the displacements and timings of each of these separators is generally oriented to obtaining good performance of the separating device in terms of speed and accuracy of carrying out the separating and sending on operations of the bundles, trying at the same time not to make the separators activating mechanisms too complex and expensive. In this connection, in the interfolding machines field, there is a very real need to improve the above mentioned separation methods, in order to make them simpler and more efficient, and consequently, to make the separating devices more reliable and less expensive.

### OBJECTS OF THE INVENTION

Actually, it is an object of the present invention to propose a new method for separation of the bundles, capable of carrying out the separating operations in a particularly simple and efficient way.

Another object of the invention is to obtain separating devices which carry out the above mentioned method, that are particularly reliable and relatively not expensive, as a direct result of their constructive simplicity.

### SUMMARY OF THE INVENTION

The above mentioned objects are wholly obtained, in accordance with the contents of the claims, by a method for automatic separation of bundles of interfolded sheet articles, which is carried out in an interfolding machine that includes a folding unit, aimed at cutting the articles, folding them and forming an interfolded stack, and that includes also a separating device, situated downstream of the folding unit.

The separation method, in its most general form, includes: the supporting of the base of the stack by means of the separator first supporting planes; the lateral inserting of second supporting planes and the subsequent forming of an underlying bundle of articles; the separation of the bundle and the release thereof onto a conveyor; the upwards movement of the first supporting planes until they are placed directly underneath the second supporting planes; the reinserting of the first supporting means under the base of the stack; the withdrawal of the second supporting planes from the stack base.

### BRIEF DESCRIPTION OF DRAWINGS

The characteristics of the invention, as they will result from the claims, are pointed out in the following detailed description, with reference to the enclosed drawing tables, in which:

figures from 1A to 1H show schematically the working step sequence of a first embodiment of the method of the present invention;

figures from 2A to 2J show schematically the working step sequence of a second embodiment of the above mentioned method.

### DETAILED DESCRIPTION OF PREFERRED EMBODIMENTS OF THE INVENTION

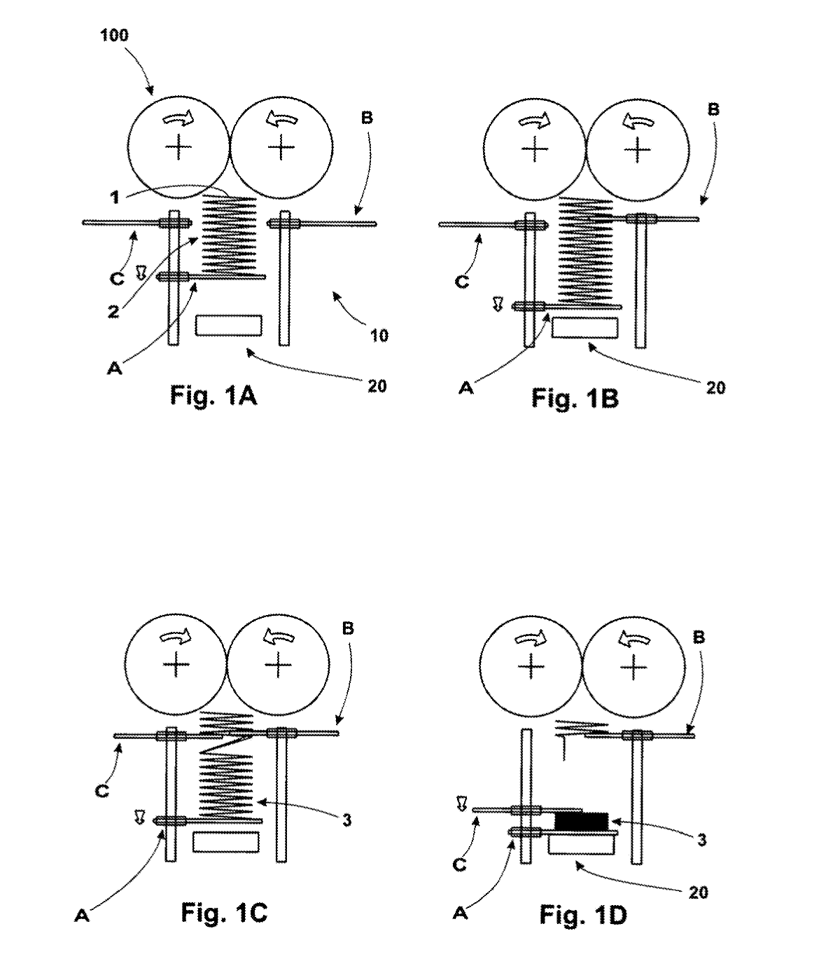

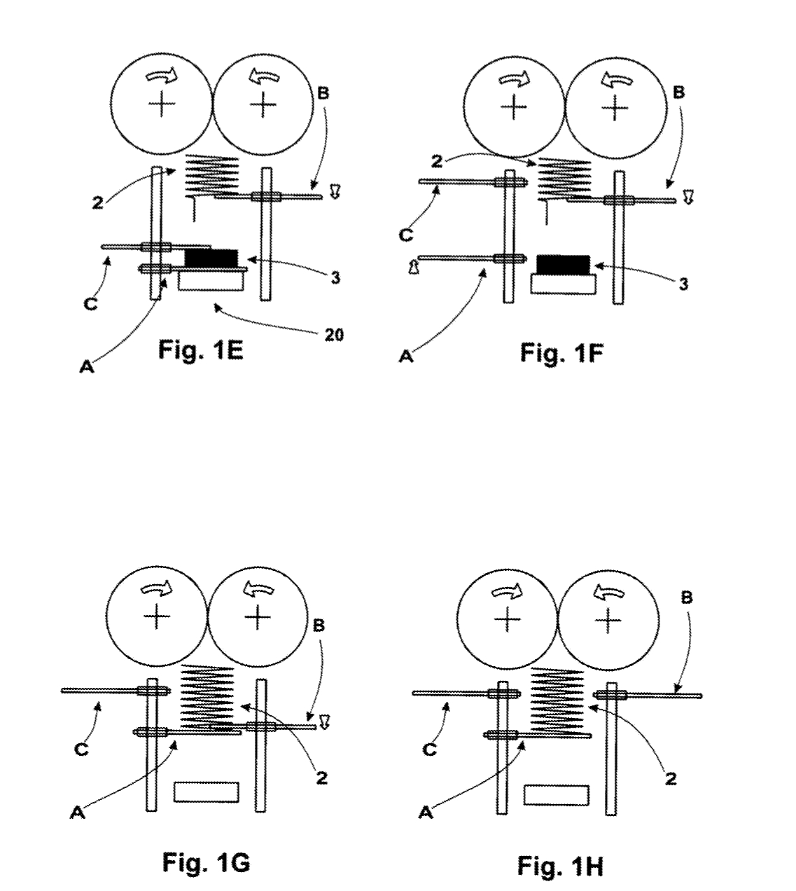

With reference to FIG. 1A, and to a first embodiment of the method in accordance with the invention, the operation means of a separating device 10 are shown, which carry out the above mentioned method, installed in an interfolding machine for sheet disposable articles 1, for example “C”, “W”, “Z” or “V”-like folded towels. In particular, these articles 1 are cut and folded in a wholly known manner in a folding unit 100, in a substantially continuous way. Each article 1 is then interfolded with the previous one and with the subsequent one, using a technique that depends on the folding way. The articles 1 are superimposed so as to form a continuously growing stack 2.

The above mentioned separating device 10 is situated downstream of the folding unit 100, generally below it, so as to receive and support from the top in a natural way the stack 2 being formed.

In the aforesaid first embodiment of the separation method, the separating device 10 includes first supporting means A, composed of a first single supporting plane, aimed at being moved in the stack 2 forming direction, that is in a vertical direction, in both senses, with predetermined speeds. The first plane A is also moveable in a direction perpendicular to that of the stack 2 formation between an engagement position thereof and a full release position thereof, in which the plane can be moved vertically without involving the stack 2 being formed.

The separating device 10 includes also second supporting means B, likewise composed of a single supporting plane, likewise moveable in both vertical and horizontal directions, to engage the stack 2 of articles 1 and consequently, to obtain the separation of a bundle 3 of articles 1 having predetermined dimensions. The second supporting plane B is arranged on the side of the stack 2 opposite with respect to the first supporting plane A.

On the same side of the stack 2 there are arranged third supporting means C, likewise composed of a supporting plane, which is moveable vertically and horizontally.

A conveying device 20, generally a belt conveyor type, is provided below the separating device 10 and is aimed at withdrawing the bundles 3 separated by the separating device 10 and at conveying them toward the subsequent steps providing cutting to size and packaging of the disposable articles 1.

The separation method according to the first embodiment includes a first working step, during which the stack 2 being formed (FIG. 1A) is supported by the first supporting plane A, wholly introduced below the stack 2 and moved in a vertical direction downwards with the same stack growth speed, so that the top of the stack is always at a constant height with respect to the folding unit 100. The second supporting plane B is in a wholly withdrawn position, at a higher level with respect to the first supporting plane A. The third supporting plane C is situated on the opposite side with respect to the second plane 13 and on the same side of the first plane A, at a level only slightly lower with respect to the level of the second plane B.

A counter device of known type counts the articles 1, resting on the first plane A and below the second plane B. As soon as the counting reaches the prefixed number of articles to be separated, a second working step is started (FIG. 1B), during which the second supporting plane B is introduced laterally into the stack 2, between two subsequent interfolded articles 1, so as to support the upper portion of the stack 2 and to define a bundle 3 of articles 1 between the first and second supporting planes. The second supporting plane B is also moved downwards with the same speed of the stack 2 formation speed, so as to continue supporting the growing stack.

The second plane B is introduced into the stack 2 along the whole extension of the base of the stack 2 or along a portion thereof, in any case greater than a half of its base surface, so as to assure the support stability.

At this point, during a third working step of the method (FIG. 1C), the first supporting plane A is accelerated downwards, until the base of the bundle 3 is brought substantially to the height of the conveying device 20.

According to a different version of the method in its first embodiment, when the top of the bundle 3 has been spaced apart sufficiently (some centimeters) from the base of the overlaying stack 2 during the above described third working step, the aforesaid third plane C is introduced laterally and subsequently it is moved downwards with a speed that allows it to reach the top of the bundle 3 and to pack by compression the same bundle (FIGS. 1D, 1E).

When, upon the ending of the aforesaid third working step, the base of the bundle 3 is situated near the height of the conveying device 20, a fourth step of the method is started (FIG. 1F), that includes the return of the first supporting plane A, with consequent release of the bundle 3 onto the conveyor 20. Such a return is possibly preceded, in the case of the above described version of the method, by the horizontal return of the third plane C and its vertical repositioning up to the starting position.

Consequently, also the first supporting plane A is repositioned moving in vertical direction during a fifth working step, until it is brought again to a height directly below the height reached by the second plane B.

During a sixth working step (FIG. 1G), the first plane A is subsequently re-introduced below the base of the stack 2, and, at the same time, it is brought again to move downwards with a speed equal to the stack 2 forming speed.

At this point, during the seventh and last step of the present method (FIG. 1H), the second supporting plane B is withdrawn from the base of the stack 2 and repositioned moving vertically to its start position, while the stack 2 is supported again by the first supporting plane A.

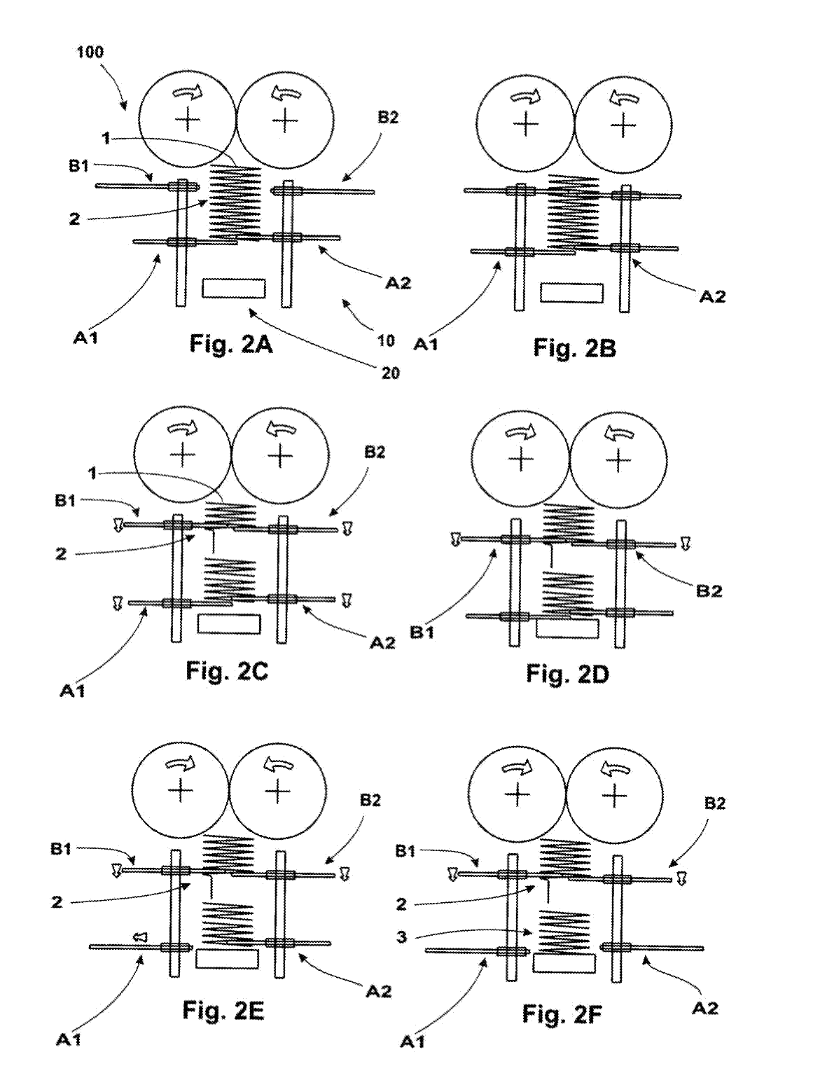

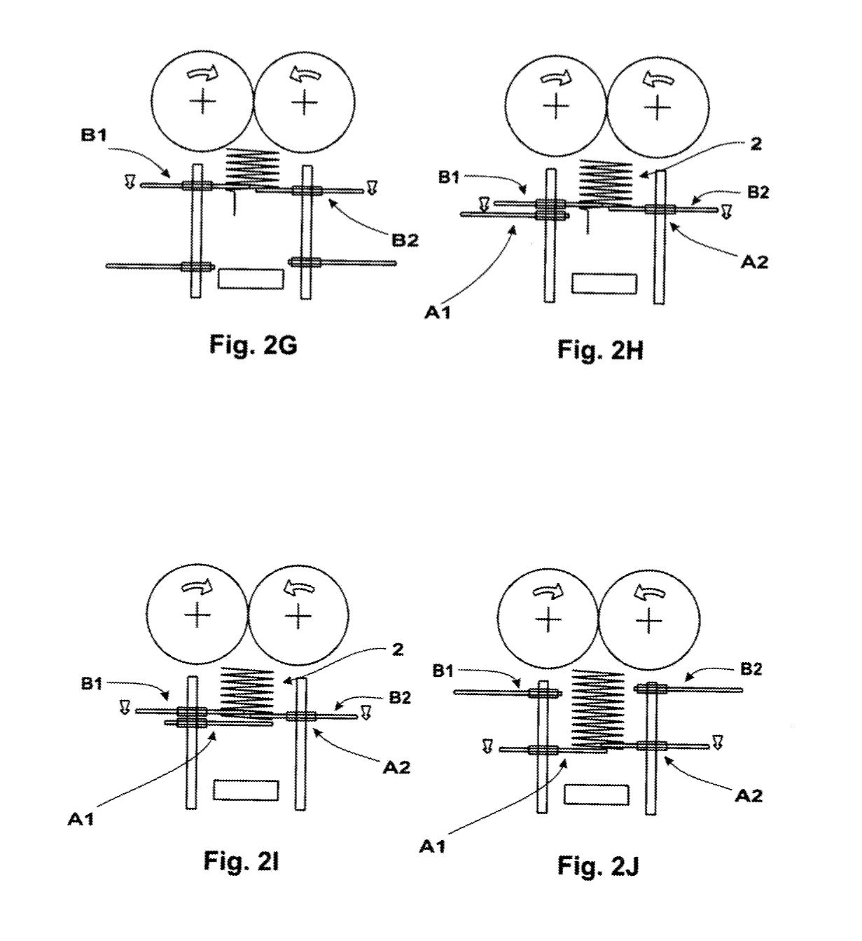

A second embodiment of the separation method proposed by the invention is shown in FIGS. 2A to 2J.

According to this embodiment, the first supporting means A include a first pair of supporting planes A1, A2, arranged on the opposite sides with respect to the stack 2 being formed. The planes A1, A2 move independently from each other in the direction of the stack 2 formation, and consequently, substantially vertical, and in a direction perpendicular thereto, to engage and disengage the stack 2.

The second supporting means B include, in turn, a second pair of supporting planes B1, B2, likewise arranged on the opposite sides with respect to the stack 2 and moving independently, both in vertical and in horizontal directions, in a way similar to the above described first pair of planes A1, A2. According to the separation method in accordance with the aforesaid second embodiment, for the separation and sending on of each bundle 3 of articles 1, a sequence of working steps must be performed, beginning from a start position in which (first step, see FIG. 2A), the first pair of planes A1, A2 is in a position in which it supports the stack 2 being formed. Each of the above mentioned planes A1, A2 extends below the base of the stack 2 substantially along a half of its length. As a consequence of the folding and interfolding of the articles 1, the planes A1, A2 involve the consecutive layers of an article 1, and not the same layer.

The pair of planes A1, A2 are moved together in a vertical direction of the stack 2 growth, so as to keep the top of the stack always at the same height. The second pair of supporting planes B1, B2 are situated in the rest position, above the first pair A1, A2.

When the articles 1 counter reaches a prefixed value, the second pair of supporting planes B1, B2 are operated together (second step, FIG. 2B), introduced laterally into the stack 2, between the two subsequent articles 1, and moved vertically downwards with the same speed of the stack 2 formation, so as to support the upper portion of the latter and to define an underlying bundle 3.

In a subsequent third step (FIG. 2C), the first pair of planes A1, A2 are moved downward at a higher speed with respect to that of the stack 2 formation, until the base of the bundle 3 is brought to the height of the conveying device 20 (FIG. 2D).

During the subsequent fourth step (FIGS. 2E, 2F), the first pair of planes A1, A2 are withdrawn from the bundle 3, which causes the release thereof onto the conveying device 20. During this step, the planes A1, A2 are preferably withdrawn in sequence, with the plane A1, that involves the lower layer of the last article 1 of the stack 2, being withdrawn first, even if the simultaneous withdrawing could be tolerated anyway, and is to be considered within the present method.

During the fifth working step of the method (FIGS. 2G, 2H), the first pair of planes A1, A2 are moved upwards and brought back directly below the second pair of supporting planes B1, B2, and then it is moved downwards with the same speed of the latter.

Afterwards (sixth step, FIG. 2H), the first pair of supporting planes A1, A2 is re-introduced below the base of the stack 2 and below the second pair of supporting planes B1, B2. Also in this case, the plane A1, aimed at supporting the lower layer of the last article 1 of the stack 2, is preferably introduced first, and then the other plane A2 is introduced directly above, in correspondence to the same layer engaged by the corresponding plane B2 of the second pair of supporting planes B1, B2.

During the seventh working step (FIG. 2D, the second pair of supporting planes B1, B2 are eventually withdrawn from the base of the stack 2 and then moved upwards so as to be brought back to the original rest position, from which a further cycle for separation of a bundle 3 will be started afterwards.

The advantages, allowed by the above described separation method in its different embodiments, derive first of all from the particular simplicity while carrying out the separating operations, which require simple separating devices.

Another, consequent advantage provided by the present method derives from the reliability of the separating devices which carry it out, and from the reasonable production costs, which constitute a direct result of their constructive simplicity.

It is understood that what above has been described as a pure not limiting example. Therefore, possible modifications and variations of the invention are considered within the protective scope of the present technical solution, as described above and claimed below.

1. A method for automatic separation of bundles of interfolded sheet articles in an interfolding machine, said machine having a folding unit (100), aimed at cutting said sheet articles (1), at folding them and forming a stack (2) of said superimposed and interfolded articles (1), that grows in a substantially continuous way, said machine having a separating device (10) arranged downstream of said folding unit (100), said method comprising the following operating steps:
a first supporting step, in which the base of said growing stack (2) of interfolded articles (1) is supported by first supporting means (A) of said separating device (10), said first supporting means (A) being moved downwards, according to the same growing direction of said stack (2), with such a speed that the top of said stack (2) is held at a constant height;
a second insertion step, in which second supporting means (B) are inserted from one side into said stack (2), between two consecutive interfolded articles (1), so that the upper portion of said stack (2) is supported by said second supporting means (B), and a bundle (3) of said articles is defined between said first supporting means (A) and said second supporting means (B), the latter being moved also downwards at the same speed as the stack (2) forming speed;
a third downward translation step, in which said first supporting means (A) move downwards with a speed which is greater than the stack (2) forming speed, until the base of said bundle (3) has reached a height close to the transporting height of a conveying device (20);
a fourth withdrawing step of said first supporting means (A) from said bundle (3), with a subsequent release of said bundle (3) on said conveying device (20);
a fifth moving step, in which said first supporting means (A) are moved upwards until they are placed directly underneath said second supporting means (B);
a sixth re-inserting step, in which said first supporting means (A) are inserted under the base of said stack (2), and also translated downwards at a speed equal to the stack (2) forming speed;
a seventh withdrawing step, in which said second supporting means (B) are withdrawn from the base of said stack (2).

2. The method according to claim 1, characterized in that said first supporting means (A) comprise a first single supporting plane, and in that said second supporting means (B) comprise a second single supporting plane.

3. The method according to claim 1 wherein, during said second inserting step, said second supporting plane (B) is inserted into said stack (2) at a position that is up to approximately a half of the stack base width.

4. The method according to claim 1 wherein, after said second inserting step for said second supporting plane (B), there is provided a further inserting step, in which a third horizontal supporting plane (C) is inserted into said stack (2), directly underneath said second supporting plane (B), in order to separate said bundle (3) together with said first supporting plane (A), and in which said third supporting plane (C) is moved downwards at a moving speed which is at least equal to the lowering speed of said first supporting plane (A); said third supporting plane (C) being subsequently withdrawn and moved back to its starting position together with said first supporting plane (A).

5. The method according to claim 4 wherein, said lowering step for said third supporting plane (C) is carried out at a speed higher than the lowering speed of said first supporting plane (A), so as to compact said just separated bundle (3).

6. The method according to claim 1 wherein, during said third inserting step, said third supporting plane (C) is inserted into said stack (2) up to approximately a half of the stack (2) width.

7. The method according to claim 1 wherein, said first supporting means (A) comprise a first pair of supporting planes (A1, A2), arranged at opposite sides with respect to said stack (2) being formed, and in that said supporting planes (A1, A2) are moved together.

8. The method according to claim 1 wherein, said first supporting means (A) comprise a first pair of supporting planes (A1, A2), arranged at opposite sides with respect to said stack (2) being formed, and in that, during said fourth withdrawing step, said supporting planes (A1, A2) are withdrawn one after the other.

9. The method according to claim 1 wherein, said second supporting means (B) comprise a second pair of supporting planes (131, 132), arranged at opposite sides with respect to said stack (2) being formed, and in that said second supporting planes (B1, B2) are moved together.

10. The method according to claim 1 wherein, said second supporting means (B) comprise a second pair of supporting planes (B1, B2), arranged on opposite sides with respect to said stack (2) being formed, and in that, during said second inserting step, said supporting planes (B1, B2) are inserted in said stack (2) being formed, from the opposite sides thereof, for about 30% of its width, with an offset of one article (1).

11. The method according to claim 4 wherein, during said third inserting step, said third supporting plane (C) is inserted into said stack (2) up to approximately a half of the stack (2) width.
